(19) United States
(12) Patent Application Publication
(10) Pub. No.: US 2025/0018889 A1
(43) Pub. Date: Jan. 16, 2025

(54) INFORMATION PROCESSING DEVICE AND VEHICLE

(71) Applicant: TOYOTA JIDOSHA KABUSHIKI KAISHA, Toyota-shi (JP)

(72) Inventors: Jun HIOKI, Nagakute-shi (JP); Rie Murai, Chiba-shi (JP); Tomonari Yamaguchi, Miyoshi-shi (JP); Fumiyuki Kagara, Sagamihara-shi (JP); Hirofumi Aino, KaWAGUCHI-SHI (JP)

(73) Assignee: TOYOTA JIDOSHA KABUSHIKI KAISHA, Toyota-shi (JP)

(21) Appl. No.: 18/645,896

(22) Filed: Apr. 25, 2024

(30) Foreign Application Priority Data
Jul. 13, 2023 (JP) 2023-115531

(51) Int. Cl. B60R 16/037; G06Q 10/02; G06Q 50/43; H04L 67/306; H04W 4/40

(52) U.S. Cl. CPC B60R 16/037; G06Q 10/02; G06Q 50/43; H04L 67/306; H04W 4/40

(57) ABSTRACT

The information processing device includes a communication unit that communicates with the vehicle, a control unit that acquires reservation information including a schedule in which the user uses the vehicle and an attribute of the user, creates profile information indicating, based on the acquired reservation information, one or more setting values associated with the attribute, a setting value for setting a device included in the vehicle by being downloaded to the vehicle as a parameter value, and transmits the created profile information to the vehicle in accordance with the schedule via the communication unit.

### CROSS-REFERENCE TO RELATED APPLICATION

This application claims priority to Japanese Patent Application No. 2023-115531 filed on Jul. 13, 2023, incorporated herein by reference in its entirety.

### BACKGROUND

### 1. Technical Field

The present disclosure relates to an information processing device and a vehicle.

### 2. Description of Related Art

Japanese Unexamined Patent Application Publication No. 2016-215817 (JP 2016-215817 A) describes an electronic key system including an in-vehicle control unit that permits or executes operation of an in-vehicle device on condition that wireless communication between an in-vehicle communication device provided in a vehicle and an electronic key is established.

### SUMMARY

Rental car services and car sharing services in which cars are shared among a plurality of users are in widespread use. In general, a driving position or the like in a vehicle is different among users. Therefore, the users take the trouble of adjusting the driving position or the like in a reserved vehicle to themselves, for example, when using a one-time use vehicle that is used by a large number of unspecified users in rental car services, car sharing services, or the like.

In the electronic key system described in JP 2016-215817 A, attention is given to the fact that a specific individual often uses one electronic key, and a user that gets into a vehicle is identified from information unique to an electronic key wirelessly transmitted from the electronic key, and an in-vehicle device is caused to operate so as to correspond to the user. In the technology described in JP 2016-215817 A, it is necessary to identify a user by communicating with an electronic key, in order to adjust the setting or the like of a device of a reserved vehicle so as to match the user.

An object of the present disclosure is to make it possible to adjust the setting of a device of a vehicle to a user without communicating with an electronic key.

An aspect of the present disclosure provides an information processing device including:
a communication unit that communicates with a vehicle; and
a control unit that acquires reservation information including a schedule of a user to use the vehicle and an attribute of the user, prepares profile information based on the acquired reservation information, the profile information indicating as parameter values one or more setting values correlated with the attribute and for performing setting of a device provided in the vehicle by being downloaded to the vehicle, and transmits the prepared profile information to the vehicle via the communication unit according to the schedule.

According to the present disclosure, it is possible to adjust the setting of a device of a vehicle to a user without communicating with an electronic key.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of an information processing system according to an embodiment of the present disclosure;

FIG. 2 is a block diagram illustrating a configuration of an information processing device according to an embodiment of the present disclosure;

FIG. 3 is a block-diagram illustrating a configuration of a vehicle according to an embodiment of the present disclosure; and

FIG. 4 is a flowchart illustrating an operation of the information processing system according to the embodiment of the present disclosure.

### DETAILED DESCRIPTION OF EMBODIMENTS

Hereinafter, embodiments of the present disclosure will be described below with reference to the drawings.

In each drawing, the same or corresponding portions are denoted by the same reference signs. In the description of the present embodiment, description of the same or corresponding components will be appropriately omitted or simplified.

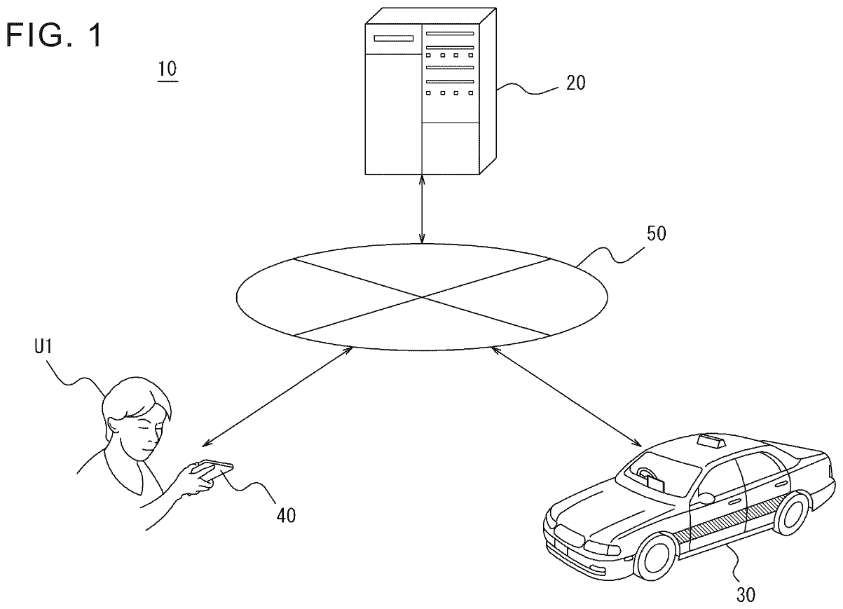

A configuration of the information processing system 10 according to the present embodiment will be described with reference to FIG. 1.

The information processing system 10 includes at least one information processing device 20, at least one vehicle 30, and a user U1 terminal device 40. Note that there may be a plurality of information processing devices 20, a plurality of vehicles 30, and a plurality of terminal devices 40.

The information processing device 20 is capable of communicating with the vehicle 30 and the terminal device 40 via the network 50.

The information processing device 20 is installed in a facility such as a data center. The information processing device 20 is, for example, a server belonging to a cloud computing system or another computing system.

Vehicle 30 may be any type of vehicle, such as, for example, a gas-powered vehicle, a die-powered vehicle, a HEV, PHEV, BEV, or a FCEV. “HEV” is an abbreviation for hybrid electric vehicle. “PHEV” is an abbreviation for plug-in hybrid electric vehicle. “BEV” is an abbreviation for battery electric vehicle. “FCEV” is an abbreviation for fuel cell electric vehicle.

In the present embodiment, the terminal device 40 is held by a user U1. The terminal device 40 is, for example, a mobile device such as a mobile phone, a smart phone, or a tablet, or a general-purpose terminal such as a PC. “PC” is an abbreviation for personal computer.

The network 50 includes the Internet, at least one WAN, at least one MAN, or a combination thereof. “WAN” is an abbreviation for wide area network. “MAN” is an abbreviation for metropolitan area network. The network 50 may include at least one wireless network, at least one optical network, or a combination thereof. The wireless network is, for example, an ad hoc network, a cellular network, a wireless LAN, a satellite communication network, or a terrestrial microwave network. “LAN” is an abbreviation for local area network.

The outline of the present embodiment will be described with reference to FIG. 1.

In the present embodiment, the vehicle 30 is a one-time use vehicle such as a rental car or a share car. One-time use means that a vehicle is used by a plurality of users on different schedules that do not overlap. The vehicle 30 may be a vehicle selected from a plurality of vehicles. Each of the plurality of users makes a reservation by specifying a schedule SH including a date and time at which use of the vehicle 30 is desired. It is assumed that the plurality of users include a user U1. For example, when the user U1 has designated a schedule SH1 to reserve the vehicle 30, the vehicle 30 is used by the user U1 for the duration P1 of the schedule SH1.

In general, a driving position in a vehicle, that is, a position of a seat, a handle, and the like of a driver's seat is adjusted according to physical characteristics such as a height, a weight, an age, and a gender of a user who is a driver. The same applies to devices other than the seat and the handle, for example, the side door mirror and the inner mirror. Further, for example, specifications such as the volume setting and the car navigation setting of the car audio included in the vehicle differ from user to user. Therefore, in a one-time use vehicle in which a vehicle is shared by a plurality of persons, such as a rental car or a share car, each user must adjust the settings of the devices of these vehicles to suit himself/herself every time the user changes.

As a method of automatically adjusting the setting of the device of the vehicle, for example, it is conceivable that, after the user gets into a certain vehicle and performs the vehicle setting, the result is associated with the electronic key of the user, and when the user gets on the same vehicle next time, the vehicle setting stored in the electronic key is reflected. However, in such a method, in order to adjust the setting of the device of the reserved vehicle so as to suit the user, it is necessary to identify the user by communicating with the electronic key. In addition, when a rental car or a share car that has not been boarded by the user has been used for the first time, or when the result is not associated with the electronic key even if the vehicle setting has been made, even if communication with the electronic key is performed, since there is no data to be referred to, the setting of the device of the vehicle cannot be automatically adjusted to the user.

In the present embodiment, the user U1 who intends to reserve the vehicle 30 accesses any reservation system via the terminal device 40. The user U1 performs login by inputting a user ID, a password, and the like. “ID” is an abbreviation for identifier. The user U1 inputs information including a duration P1 and other schedule SH1 and attribute T1 of the user U1 for which use of the vehicle 30 is desired. In the present embodiment, the attribute T1 of the user U1 includes values that are considered for adjusting the settings of the devices of the vehicle 30. For example, when an attempt is made to change the setting of the position of the seat and the steering wheel of the driver's seat in accordance with the user U1 in order to determine the driving position of the vehicle 30, physical characteristics such as the height, weight, age, and gender of the user U1 are included in the attribute T1 of the user U1. Note that the attribute T1 of the user U1 may be appropriately selected according to information required for the information processing device 20 to create the profile information D2, as will be described later. The information indicating the attribute T1 of the user U1 may be stored in any servers in association with the user ID in advance, or may be constructed on the cloud as a database with the user ID as the primary key. In the present embodiment, the reservation system is constructed on a reservation platform operated by a rental car operator or a share car operator. The reservation system may be constructed on a reservation platform operated by a reservation management business operator.

In the information processing system 10 according to the present embodiment, the information processing device 20 accesses the reservation platform and acquires the reservation information D1. The reservation information D1 is information that is inputted by the user U1 via the terminal device 40 and includes schedule SH1 and user U1 attribute T1 that the user U1 desires to use the vehicle 30. Based on the acquired reservation information D1, the information processing device 20 creates a profile information D2 indicating one or more setting values associated with the attribute T1 as parameter value Pv. The information processing device 20 transmits the created profile information D2 to the vehicle 30 in accordance with the schedule SH1. The vehicle 30 receives the transmitted profile information D2 and downloads it to the vehicle 30. When the profile information D2 is downloaded to the vehicle 30, the device 34 included in the vehicle 30 is set in accordance with the parameter value Pv indicated by the profile information D2.

In the present embodiment, the “device” included in the vehicle 30 includes, for example, a seat, a handle, a side door mirror, an inner mirror, a head-up display, and the like of a driver's seat in the vehicle 30. The “device” included in the vehicle 30 may include a car navigation system and/or an audio system mounted on the vehicle 30.

In the present embodiment, the one or more parameter values Pv indicated by the profile information D2 may be values packaged as a set of setting values of respective devices in the vehicle 30. The information processing device 20 can refer to the attribute T1 of the user U1 included in the reservation information D1, extract the setting value packaged in association with the attribute T1, and create information indicating the extracted setting value as the parameter value Pv as the profile information D2. For example, the driving position of the vehicle is set using the height of the driver driving the vehicle 30 as a key factor. Therefore, it is conceivable that the set value group of the driving position is packaged in advance for each height value. The set value group of the driving position can include, for example, a set value of the position of the handle and a set value of the position of the sheet. The information processing device 20 can refer to the height of the user U1 as the attribute T1 of the user U1, extract a set value group packaged with respect to the value of the height, and create information indicating the extracted set value group as the parameter value Pv as the profile information D2. The information processing device 20 may refer to the weight of the user U1 in addition to the height of the user U1 indicated as the attribute T1 of the user U1, and may create the profile information D2. Specifically, the information processing device 20 may estimate the body shape of the user U1 from the height and weight of the user U1, and finely adjust the extracted set-value group based on the estimated body shape. Alternatively, the information processing device 20 may refer to the gender or age of the user U1 in addition to the height of the user U1 indicated as the attribute T1 of the user U1, and may create the profile information D2. Specifically, the information processing device 20 may create, as the profile information D2, information indicating, as the parameter value Pv′, a value obtained by multiplying the value included in the set value group for each height value by a predetermined factor for each sex or age. The information processing device 20 may extract a set value group for setting, for example, a side door mirror, an inner mirror, a steering position, a head-up display, or a combination thereof as a device of the vehicle 30 in place of the set value group of the driving position or in addition to the set value group of the driving position, and generate information indicating the extracted set value group as the parameter value Pv as the profile information D2. In addition, a set value group related to a car navigation system, an audio system, or the like may be packaged in association with age and/or gender, for example. The information processing device 20 may refer to the age and/or gender of the user U1 as the attribute T1 of the user U1, extract a set value group packaged with respect to the value of the age and/or gender, and create information indicating the extracted set value group as the parameter value Pv as the profile information D2.

According to the present embodiment, when the user U1 makes a reservation for the vehicle 30, the setting of the device of the vehicle 30 suitable for the user U1 is obtained based on the reservation information D1 of the user U1. Therefore, the information processing device 20 can adjust the setting of the device of the vehicle 30 without communicating with the electronic key of the user U1. For example, in a vehicle such as a share car or a rental car, a profile package recommended for the user U1 may be extracted from the pre-ride state based on the attribute T1 such as the height, weight, sex, and age of the user U1 included in the reservation information D1 of the vehicle. Therefore, according to the present embodiment, it is possible to set the device of the vehicle before the user actually gets on the vehicle. As a result, it is possible to contribute to the effective utilization of the time resource of the user. That is, according to the present embodiment, it is possible to automatically adjust the setting of the device of the vehicle in accordance with the user. Therefore, the technique of adjusting the setting of the equipment of the vehicle is improved. As a result, convenience is improved.

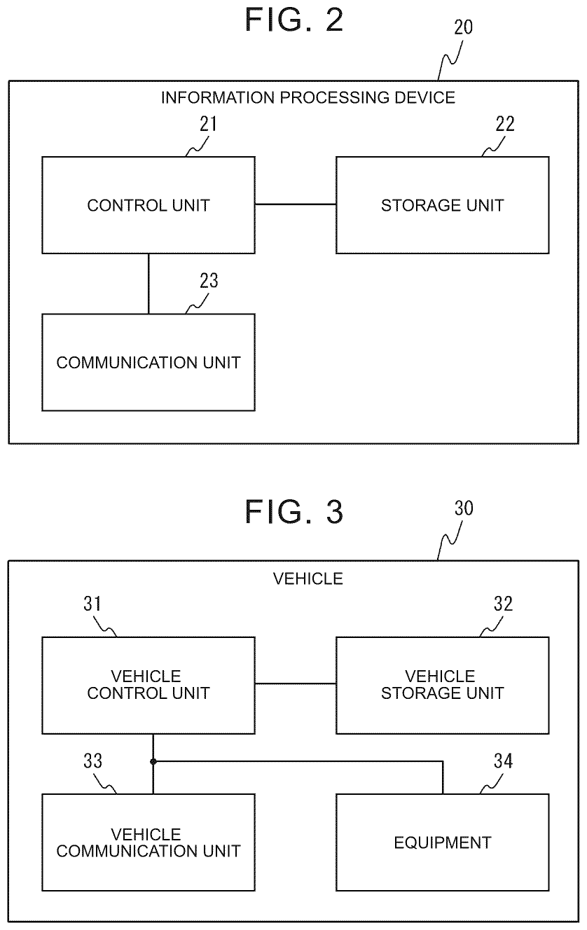

The configuration of the information processing device 20 according to the present embodiment will be described with reference to FIG. 2.

The information processing device 20 includes a control unit 21, a storage unit 22, and a communication unit 23.

The control unit 21 includes at least one processor, at least one programmable circuit, at least one dedicated circuit, or a combination thereof. A processor is a general-purpose processor, such as a CPU or GPU, or a special-purpose processor specialized for a particular process. “CPU” is an abbreviation for central processing unit. “GPU” is an abbreviation for graphics processing unit. The programmable circuitry is, for example, a FPGA. “FPGA” is an abbreviation for field-programmable gate array. The dedicated circuitry is, for example, a ASIC. “ASIC” is an abbreviation for application specific integrated circuit. The control unit 21 executes processes related to the operation of the information processing device 20 while controlling various units of the information processing device 20.

The storage unit 22 includes at least one semiconductor memory, at least one magnetic memory, at least one optical memory, or a combination of at least two of them. The semiconductor memory is, for example, a RAM or a ROM. “RAM” is an abbreviation for random access memory. “ROM” is an abbreviation for read only memory. RAM is, for example, SRAM or DRAM. “SRAM” is an abbreviation for static random access memory. “DRAM” is an abbreviation for dynamic random access memory. ROM is, for example, EEPROM. “EEPROM” is an abbreviation for electrically erasable programmable read only memory. The storage unit 22 functions as, for example, a main storage device, an auxiliary storage device, or a cache memory. The storage unit 22 stores data used for the operations of the information processing device 20 and data obtained through the operations of the information processing device 20. In the present embodiment, a profile package associated with various attribute T1 may be recorded in the storage unit 22. In addition, the storage unit 22 may store history-information D3. The history information D3 will be described later.

The communication unit 23 includes at least one communication interface. The communication interface is, for example, a LAN interface. The communication unit 23 receives data used for the operation of the information processing device 20 and transmits data obtained by the operation of the information processing device 20. In the present embodiment, the communication unit 23 communicates with the vehicle 30. The communication unit 23 also communicates with the terminal device 40.

The function of the information processing device 20 is realized by executing the information processing program according to the present embodiment by a processor serving as the control unit 21. That is, the functions of the information processing device 20 are realized by software. The information processing program causes the computer to function as the information processing device 20 by causing the computer to execute the operation of the information processing device 20. That is, the computer functions as the information processing device 20 by executing the operation of the information processing device 20 in accordance with the information processing program.

The program can be stored in a non-transitory computer-readable medium. The non-transitory computer-readable medium is, for example, a flash memory, a magnetic recording device, an optical disc, a magneto-optical recording medium, or a ROM. Distribution of the program is performed, for example, by selling, transferring, or lending a portable medium such as a SD card, DVD, or CD-ROM storing the program. “SD” is an abbreviation for Secure Digital. “DVD” is an abbreviation for digital versatile disc. “CD-ROM” is an abbreviation for compact disc read only memory. The program may be stored in the storage of the server and transferred from the server to other computers to distribute the program. The program may be provided as a program product.

The computer temporarily stores the program stored in the portable medium or the program transferred from the server in the main storage device, for example. The computer then causes the processor to read the program stored in the main storage device, and causes the processor to execute processes in accordance with the read program. The computer may read the program directly from the portable medium and execute processes in accordance with the program. The computer may execute the processes in accordance with the received program each time the program is transferred from the server to the computer. The process may be executed by a so-called ASP type service which realizes a function only by an execution instruction and a result-acquisition, without transferring a program from the server to the computer. “ASP” is an abbreviation for application service provider. The program includes information that is used for processing by electronic computers and equivalent to a program. For example, data that is not a direct command to a computer but has the property of defining the process of the computer corresponds to the “data equivalent to a program”.

Part or all of the functions of the information processing device 20 may be realized by a programmable circuit or a dedicated circuit as the control unit 21. That is, some or all of the functions of the information processing device 20 may be realized by hardware.

The configuration of the vehicle 30 according to the embodiment will be described with reference to FIG. 3.

The vehicle 30 includes a vehicle control unit 31, a vehicle storage unit 32, a vehicle communication unit 33, and a device 34.

The vehicle control unit 31 includes at least one processor, at least one programmable circuit, at least one dedicated circuit, or a combination thereof. The processor is a general-purpose processor such as a CPU or a GPU, or a dedicated processor specialized for a specific process. The programmable circuit is, for example, an FPGA. The dedicated circuit is, for example, an ASIC. The vehicle control unit 31 executes processing related to the operation of the vehicle 30 while controlling each functional component of the vehicle 30.

The vehicle storage unit 32 includes at least one semiconductor memory, at least one magnetic memory, at least one optical memory, or a combination of at least two of these. The semiconductor memory is, for example, a RAM or a ROM. The RAM is, for example, a static random access memory (SRAM) or a dynamic random access memory (DRAM). The ROM is, for example, an EEPROM. The vehicle storage unit 32 functions as, for example, a main storage device, an auxiliary storage device, or a cache memory. The vehicle storage unit 32 stores data used for the operation of the vehicle 30 and data obtained by the operation of the vehicle 30. In the present embodiment, the profile information D2 downloaded from the information processing device 20 may be stored in the vehicle storage unit 32.

The vehicle communication unit 33 includes at least one communication interface. The communication interface is, for example, a LAN interface. The vehicle communication unit 33 receives data used for the operation of the vehicle 30 and transmits data obtained by the operation of the vehicle 30.

The device 34 is a variety of functional components and devices mounted on the vehicle 30, and in particular, is a functional component and device controlled and adjusted by the vehicle control unit 31. In the present embodiment, as described above, a seat, a handle, a side door mirror, an inner mirror, a head-up display, a car navigation system, an audio system, and the like of a driver's seat in the vehicle 30 may be included.

The function of the vehicle 30 is realized by executing an arbitrary vehicle program by a processor as the vehicle control unit 31. That is, the functions of the vehicle 30 are realized by software. The vehicle program causes the computer to execute the operation of the vehicle 30, thereby causing the computer to function as a control device for the vehicle 30.

Some or all of the functions of the vehicle 30 may be realized by a programmable circuit or a dedicated circuit as the vehicle control unit 31. That is, some or all of the functions of the vehicle 30 may be realized by hardware.

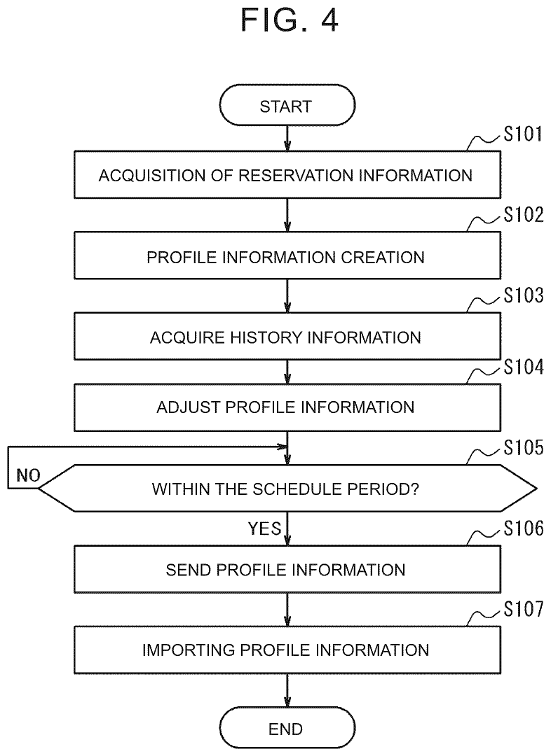

An operation of the information processing system 10 according to the present embodiment will be described with reference to FIG. 4. This operation corresponds to an information processing method according to the present embodiment.

It is assumed that a user U1 who desires to use the vehicle 30 logs into the reservation system by inputting a user ID, a password, and the like for identifying a user U1 via the terminal device 40, and makes a reservation of the vehicle 30. Although the reservation of the vehicle 30 may be performed by any procedure, in the present embodiment, the user U1 inputs, to the terminal device 40, the duration P1 for which the use of the vehicle 30 is desired, and also inputs the height, the weight, the sex, and the age as the attribute T1 of the user. The terminal device 40 transmits information indicating the duration P1 and the attribute T1 inputted by the user U1 to the reservation system as the reservation information D1. The reservation system receives the reservation information D1 and stores it in storage of the reservation system.

In S101, the control unit 21 of the information processing device 20 acquires the reservation information D1. Specifically, the control unit 21 communicates with the reservation system. A reservation information D1 is transmitted from the reservation data. The control unit 21 receives the reservation information D1 transmitted from the reservation system via the communication unit 23. As an example, it is assumed that the reservation information D1 includes information indicating the duration P1 as the schedule SH that the user U1 uses the vehicle 30, and the height, weight, sex, and age of the user U1 as the attribute T1 of the user U1.

In S102, the control unit 21 of the information processing device 20 creates the profile information D2 based on the reservation information D1 acquired by S101. In the present embodiment, the profile information D2 is information indicating one or more parameter value Pv associated with the attribute T1 of the user U1. When the profile information D2 is downloaded to the vehicle 30, one or more parameter values Pv are reflected in the device 34 included in the vehicle 30, and the device 34 can be set. The profile information D2 may be created by any procedure, but is created by the following procedure, for example.

For example, it is assumed that D1 acquired by S101 includes a height as the attribute T1 of the user U1. In addition, it is assumed that a database capable of extracting one or more setting values is constructed in the storage unit 22 of the information processing device 20 using the height value as a main key. The control unit 21 of the information processing device 20 reads the database from the storage unit 22, and extracts one or more setting values extracted using the height value of the user U1 included in the reservation information D1 as the main key. The control unit 21 creates information indicating the extracted one or more setting values as profile information D2 indicating one or more parameter value Pv associated with the attribute T1 of the user U1.

As a modification of the present embodiment, the control unit 21 of the information processing device 20 may further acquire the history information D3 indicating the driving record of the user U1, and adjust the profile information D2 based on the acquired history information D3. Specifically, the following S103 and S104 processes may be further performed.

In S103, the control unit 21 of the information processing device 20 acquires the history information D3 indicating the driving record of the user U1. In the present embodiment, the history information D3 is stored in the storage unit 22 in the present embodiment, but may be stored in an external storage and referred to by the control unit 21 of the information processing device 20. In the present embodiment, the operation record of the user U1 indicated by the history information D3 includes the type of the device used in the vehicles used by the user U1 in the past and the record of the setting value set by the user U1 with respect to the device of the type.

In S104, the control unit 21 of the information processing device 20 adjusts the profile information D2 based on the history information D3 acquired in S103. Specifically, the control unit 21 compares the type of the device 34 that is set by one or more parameter values Pv indicated by the profile information D2 with the type of the device included in the operation record of the user U1 indicated by the history information D3. Then, the control unit 21 adjusts the profile information D2 in accordance with the comparison. For example, the control unit 21 compares the type of the device 34 that is set by the one or more parameter value Pv indicated by the profile information D2 with the type of the device included in the operation record, and when it is determined that the device is of the same type, the control unit 21 corrects the profile information D2 so as to be information indicating, as the parameter value Pv, the most frequently used setting value among the setting values recorded in the operation record for the device in place of the one or more setting values extracted by S102. As described above, the control unit 21 of the information processing device 20 compares the type of the device 34 that is set by the one or more parameter values Pv indicated by the profile information D2 with the type of the device included in the operation recording, and adjusts the profile information D2 according to the comparison. According to this modification, since the setting value set by the user himself/herself is reflected in the device 34 as the parameter value Pv, it is possible to perform the setting more suitable for the user's preference.

In S105, the control unit 21 of the information processing device 20 determines whether or not it is within the duration P1 of the schedule SH1 indicated by the reservation information D1. When it is determined that the time is within the duration P1 of the schedule SH1, S106 process is performed. If it is determined that the time is not within the duration P1 of the schedule SH1, S105 process is performed again after a predetermined time.

In S106, the control unit 21 of the information processing device 20 transmits the profile information D2 created by S102 to the vehicle 30 via the communication unit 23. The profile information D2 may be transmitted at any timing as long as it is within the duration P1 of the schedule SH1, but for example, the control unit 21 transmits the profile information D2 to the vehicle 30 upon detecting that the vehicle 30 has been started within the duration P1 of the schedule SH1.

In S107, the vehicle control unit 31 of the vehicle 30 receives the profile information D2 transmitted from the information processing device 20 via the vehicle communication unit 33. The vehicle control unit 31 adjusts the setting of the device 34 of the vehicle 30 based on the profile information D2. Specifically, the vehicle control unit 31 performs control to reflect the parameter value Pv indicated by the profile information D2 on the device 34 included in the vehicle 30, thereby adjusting the setting of the device 34 of the vehicle 30.

As described above, the information processing device 20 acquires the reservation information D1 including the schedule SH1 for the user U1 to use the vehicle 30 and the attribute T1 of the user U1. Based on the acquired reservation information D1, the information processing device 20 creates a profile information D2 that is one or more parameter value Pv associated with the attribute T1 and that is downloaded to the vehicle 30 and indicates a parameter value Pv for causing the device 34 included in the vehicle 30 to be set. The information processing device 20 transmits the created profile information D2 to the vehicle 30 in accordance with the schedule SH1.

According to the present embodiment, when the user reserves the vehicle, the setting of the device of the vehicle is automatically adjusted in accordance with the reserved schedule. For example, the user is not required to adjust the driving position or the like of the reserved vehicle so as to suit himself/herself, and thus the time resource of the user can be effectively utilized. Further, since the setting of the device of the vehicle can be adjusted without performing communication with the electronic key, the vehicle setting can be automatically adjusted even in the case of a user whose information is not registered in the electronic key. Therefore, the convenience of the vehicle setting is improved.

As a modification of the present embodiment, the control unit 21 of the information processing device 20 may receive the profile request RQ from the vehicle 30 and then transmit the profile information D2 in the duration P1 of the schedule SH1 indicated by the reservation information D1. Specifically, in the above-described S105, the control unit 21 of the information processing device 20 may determine whether or not the schedule SH1 indicated by the reservation information D1 is within the duration P1, and may further determine whether or not there is a profile request RQ from the vehicle 30. The profile request RQ may be transmitted in any manner, but for example, the profile request RQ may be transmitted from the vehicle 30 to the information processing device 20 by triggering the vehicle 30 to be started. In S105, when the control unit 21 receives the profile request RQ transmitted from the vehicle 30 via the communication unit 23, S106 process is performed. S105 process is repeated until the control unit 21 receives the profile request RQ from the vehicle 30.

As another modification of the present embodiment, after the user U1 reserves the vehicle 30, the control unit 21 of the information processing device 20 may transmit, to the terminal device 40 of the user U1, the profile information D2 prior to duration P1 of the schedule SH1 being started. Specifically, the control unit 21 transmits the profile information D2 created in S102 or S104 to the terminal device 40 of the user U1. Further, the control unit 21 may propose a profile to the user U1 by inquiring the user U1 whether or not to adjust the setting of the device 34 of the vehicle 30 based on the profile information D2. Specifically, the control unit 21 may transmit, to the terminal device 40, a message inquiring whether the user U1 wants to adjust the setting of the device 34 of the vehicle 30 by the profile information D2. Then, the control unit 21 may receive, via the communication unit 23, a response from the user U1 to the profile suggestion and the response transmitted from the terminal device 40. The control unit 21 may transmit the profile information D2 to the vehicle 30 when a response indicating acceptance of the profile proposal is received as a response from the user U1. Alternatively, when a response indicating a change request for the profile suggestion is received as a response from the user U1, the control unit 21 may change the profile information D2 based on the change request and transmit the changed profile information D2 to the vehicle 30. According to the present modification, the user U1 can select or change the profile to be applied to the determination of the vehicles to be used and the device 34 prior to boarding, thereby further improving convenience. In addition, since the device 34 can be prepared in advance, the setting can be performed reliably.

According to the present embodiment, the setting of the device of the vehicle can be adjusted to the user without performing communication with the electronic key. Therefore, the technique of adjusting the setting of the device of the vehicle is improved.

The present disclosure is not limited to the embodiment described above. For example, blocks shown in the block diagram may be integrated, or a block may be divided. Instead of executing the steps shown in the flowcharts in chronological order according to the description, the steps may be executed in parallel or in a different order, depending on the processing capacities of the devices that execute the steps, or as necessary.

Other changes may be made without departing from the scope of the present disclosure.

What is claimed is:

1. An information processing device comprising:
a communication unit that communicates with a vehicle; and
a control unit that acquires reservation information including a schedule of a user to use the vehicle and an attribute of the user, prepares profile information based on the acquired reservation information, the profile information indicating as parameter values one or more setting values correlated with the attribute and for performing setting of a device provided in the vehicle by being downloaded to the vehicle, and transmits the prepared profile information to the vehicle via the communication unit according to the schedule.

2. The information processing device according to claim 1, wherein the control unit transmits the profile information to the vehicle upon detecting that the vehicle has been started during a period of the schedule indicated by the reservation information.

3. The information processing device according to claim 1, wherein:
the control unit further acquires history information that indicates a driving record of the user; and
the control unit adjusts the profile information based on the acquired history information.

4. The information processing device according to claim 3, wherein:
the driving record includes a record of a type of a device previously used by the user and a setting value set by the user for the device of the type; and
the control unit compares a type of a device for which setting is performed using one or more parameter values indicated by the profile information with the type of the device included in the driving record, and adjusts the profile information according to a comparison result.

5. A vehicle comprising:
a vehicle communication unit that communicates with the information processing device according to claim 1; and
a vehicle control unit that receives the profile information transmitted from the information processing device via the vehicle communication unit, wherein the vehicle control unit performs control so as to adjust setting of a device provided in the vehicle by reflecting parameter values indicated by the profile information in the device.
